(19) United States
(12) Patent Application Publication
(10) Pub. No.: US 2007/0085433 A1
(43) Pub. Date: Apr. 19, 2007

(54) Motor

(76) Inventor: Ikuo Agematsu, Nagano (JP)

Correspondence Address: REED SMITH, LLP;ATTN: PATENT RECORDS DEPARTMENT, 599 LEXINGTON AVENUE, 29TH FLOOR, NEW YORK, NY, 10022-7650, US

(21) Appl. No.: 11/580,631

(22) Filed: Oct. 12, 2006

(30) Foreign Application Priority Data
Oct. 13, 2005 (JP) 2005-299026

(51) Int. Cl. H02K 5/16; H02K 1/12

(52) U.S. Cl. 310/90; 310/257

(57) ABSTRACT

A motor includes (1) a rotor including a permanent magnet fixed to a rotor shaft, (2) a stator including a rotor insertion hole and an inner periphery, where the inner periphery of the stator is oppositely disposed to the permanent magnet of the rotor and where the rotor insertion hole has a prescribed space and the rotor is inserted into the rotor insertion hole, (3) a bearing supporting one end of the rotor shaft, and (4) a bearing holder including a bearing insertion hole into which the bearing is inserted. In this motor, when an outer diameter of the permanent magnet of the rotor is set to be “A”, an inner diameter of the bearing insertion hole of the bearing holder is set to be “B”, and an inner diameter of the rotor insertion hole of the stator is set to be “C”, a relationship of “A<B<C” is satisfied.

The present invention is based on Japanese Patent Application No. 2005-299026 filed Oct. 13, 2005, the contents of which are incorporated by reference.

### BACKGROUND OF THE INVENTION

1. Field of the Invention

The present invention relates to a motor, specifically to a motor which is suitable to reduce its size.

2. Description of the Related Art

A PM type stepping motor has been conventionally known as a motor which is rotationally driven in proportion to an inputted number of pulses. For example, in a PM type stepping motor provided with pole teeth, a permanent magnet is fixed to a rotor shaft of a rotor and ring-shaped coils are wound around a stator. When a pulsed current is supplied to the ring-shaped coils, a magnetic field is generated in the pole teeth of the stator and the rotor is rotationally driven in proportion to an inputted number of pulses.

FIG. 4 is a sectional view showing a conventional structure of a PM type stepping motor 100 provided with the pole teeth.

In FIG. 4, a PM type stepping motor 100 includes a rotor 110 provided with a permanent magnet 102 fixed to a rotor shaft 101 and a stator 120 provided with a rotor insertion hole 103 within which the rotor 110 is inserted. A bottom end of the rotor shaft 101 is supported with a bearing 130 through a steel ball 104. Further, the rotor shaft 101 is supported with a bearing 130 through a steel ball 104. Further, the bearing 130 is supported so as to be capable of being displaced in an axial direction “L” of the rotor shaft 101 by a bearing holder 140 provided with a bearing insertion hole 105. A flat spring 106 for applying a pressurization to the rotor 110 in the axial direction “L” of the rotor shaft 101 is abutted against an under face of the bearing 130.

In this conventional structure of a PM type stepping motor 100, the dimensions of the rotor 110, the stator 120 and the bearing 130 are set as follows. In other words, when the outer diameter of the rotor 110 (permanent magnet 102) is set to be φA2 (mm), the inner diameter of the bearing insertion hole 105 (outer diameter of the bearing 130) is set to be φB2 (mm), and the inner diameter of the stator 120 (rotor insertion hole 103) is set to be φC2 (mm), the relationship of A2, B2 and C2 is satisfied as follows: A2<B2=C2 (see FIG. 4). The conventional PM type stepping motor 100 satisfying this relationship is assembled as follows. In other words, first, a thrust bearing 108 is fixed to a frame 107 and the stator 120 is fixed to the frame 107. Next, a bearing holder 140 is attached to the under face of the stator 120. Next, the rotor shaft 101 (rotor 110) to which the permanent magnet 102 is fixed is inserted into the rotor insertion hole 103 of the stator 120 from a bearing insertion hole 105 of the bearing holder 140 and a front end of the rotor shaft 101 is set to be engaged with the thrust bearing 108. Finally, the bearing 130 is assembled into the bearing insertion hole 105 of the bearing holder 140 from the rear side such that the steel ball 104 is held between the rotor shaft 101 and the bearing 130, and then the under face of the bearing 130 is urged by the flat spring 106.

As described above, when the conventional stepping motor 100 is assembled, the rotor 110 is inserted into the rotor insertion hole 103 of the stator 120 through the bearing insertion hole 105 of the bearing holder 140 and, for this purpose, the relationship of “A2<B2=C2” is satisfied.

In the above-mentioned stepping motor 100, it is conceivable that the relationship of “C2<B2” is satisfied. For example, in a stepping motor described in Japanese Patent Laid-Open No. Hei 9-135562, it may be structured such that the relationship of “C2<B2” is satisfied to prevent the bearing 130 from protruding into the rotor insertion hole 103. However, in this case, the bearing 130 may protrude into the rotor insertion hole 103, and the bearing 130 may be brought into contact with the stator 120 (specifically, pole teeth). In order to prevent this problem, as shown in FIG. 4, a protruded part in an axial direction may be provided at a center portion of the bearing 130.

Recently miniaturization of a motor itself is strongly required as the length and size of an electronic apparatus such as a digital camera has been reduced. However, in the conventional stepping motor (FIG. 4 and the above-mentioned reference), the size of the motor cannot be sufficiently reduced.

In other words, in the conventional stepping motor 100 in FIG. 4, for example, whose outer diameter is about φ8 mm, the length “E2” of the bearing holder 140 is set to be larger than the length “D2” of the bearing 130 that is designed in consideration of securing its strength, and the length “E2” is set to be sufficiently small (about ⅕) in comparison with the length “H2” of the stator 120. However, for example, when the outer diameter of the stepping motor 100 is set to be about φ6 mm and, as a result, when the length “H2” of the stator 120 is modified to be a shorter length “H2′”, the length “E2” of the bearing holder 140 is required to be shorter but may not be sufficiently smaller in comparison with the length “H2′” (<H2) of the stator 120. This is because, as described above, the length “E2” of the bearing holder 140 is required to be at least larger than the length “D2” of the bearing 130 which designed in consideration of securing the strength of the bearing 130 itself. As a result, the total length of the motor cannot be shorter (smaller) and thus the bearing holder 140 causes a trouble when the stepping motor 100 is mounted on a device such as a digital camera. Further, as shown in FIG. 4, formation of the protruded part at the center portion of the bearing 130 obstructs the miniaturization of the stepping motor.

Further, as shown in the stepping motor described in the above-mentioned reference, in the case that the motor is structured such that the relationship of “A2<C2<B2” is satisfied to reduce the damage of the motor in FIG. 4, when the outer diameter of the stepping motor is set to be, for example, about φ6 mm, the length “E2” of the bearing holder (140 in FIG. 4) cannot be sufficiently reduced as similarly to the stepping motor 100, and thus the miniaturization of a stepping motor cannot be sufficiently attained.

### SUMMARY OF THE INVENTION

An object of the present invention is to reduce the size of a motor, while maintaining a sufficient strength of a bearing.

In view of the problems described above, the present invention may advantageously provide a motor which is capable of reducing its size while securing a sufficient strength of the bearing.

In order to solve the above-mentioned problems, the present invention provides a motor including (1) a rotor having a permanent magnet which is fixed to a rotor shaft, (2) a stator having a rotor insertion hole and an inner periphery, where the inner periphery of the stator is oppositely disposed to the permanent magnet of the rotor and where the rotor insertion hole has a prescribed space and the rotor is inserted into the rotor insertion hole, (3) a bearing which supports one end of the rotor shaft, and (4) a bearing holder having a bearing insertion hole into which the bearing is inserted. In the motor, when an outer diameter of the permanent magnet of the rotor is set to be “A”, an inner diameter of the bearing insertion hole of the bearing holder is set to be “B”, and an inner diameter of the rotor insertion hole of the stator is set to be “C”, a relationship of “A<B<C” is satisfied.

According to this invention, in a motor which includes a rotor, a stator, a bearing and a bearing holder, an inner diameter of a bearing insertion hole provided in the bearing holder is set to be larger than an outer diameter of a permanent magnet of the rotor and set to be smaller than an inner diameter of a rotor insertion hole provided in the stator.

In the motor in accordance with the present invention, the inner diameter “B” of the bearing insertion hole, i.e., the outer diameter “B” of the bearing is set to be smaller than the inner diameter “C” of the rotor insertion hole and thus the bearing is capable of protruding into the rotor insertion hole. When the bearing is capable of protruding into the rotor insertion hole, the length in an axial direction of the bearing holder (protruded portion on the rear side of the stator) can be reduced while the length in the axial direction of the bearing remains unchanged. In addition, even when the bearing is protruded into the rotor insertion hole, since the relationship of “B<C” is satisfied, the bearing is prevented from abutting with the stator (specifically, the pole teeth).

Accordingly, downsizing of the motor itself can be attained while considering to secure a sufficient strength of the bearing and to reduce possibility of the motor damage.

In accordance with the present invention, it is required that the relationship of “A<B<C” is satisfied but it is not required that the bearing is actually protruded into the rotor insertion hole. Further, in accordance with an embodiment of the present invention, the outer diameter “A” of the permanent magnet is the largest outer diameter of the permanent magnet of the rotor, the inner diameter “B” of the bearing insertion hole is the smallest inner diameter of the bearing insertion hole of the bearing holder, and the inner diameter “C” of the rotor insertion hole of the stator is the smallest inner diameter of the rotor insertion hole, specifically, the smallest inner diameter of the inner circumference of the pole teeth which structures the stator.

In accordance with an embodiment of the present invention, a part of the bearing is protruded on the rotor insertion hole side from the bearing holder.

According to this embodiment of the present invention, a part of the bearing is protruded on the rotor insertion hole side from the bearing holder. Therefore, the length of the bearing holder can be reduced while the length of the bearing remains as it is, and thus further downsizing of the motor can be attained while securing a sufficient strength of the bearing.

In other words, according to this embodiment, the length of the bearing holder can be made smaller by permitting the bearing to protrude into the rotor insertion hole and thus the length of the motor can be also made smaller. Further, according to this embodiment having the above-mentioned structure, the protruded bearing does not abut with the stator and the function as a bearing is not damaged while the strength as a bearing is secured. Further, according to the present invention, even when the bearing holder is made of a blank material such as a sintered body which is not provided with elasticity or plasticity and thus which is not deformable, the length in the axial direction of the bearing holder can be shortened while the length of the bearing remains unchanged. Specifically, the bearing may be preferably structured of one piece of a circular plate-shaped member which includes a side circumferential face, a first flat face, and a second flat face, the two flat faces sandwiching the side circumferential face. The side circumferential face of the bearing is formed with a slide face for the bearing insertion hole of the bearing holder and a recessed part for receiving a steel ball is formed in the first flat face. The second flat face is used as an abutting face with a flat spring for applying pressurization to the bearing so that the first flat face of the bearing is urged to protrude to the rotor insertion hole side by the flat spring. When the bearing is structured as described above, where one piece of a circular plate-shaped member can be used as the bearing, for example, the bearing does not need to be structured such that a center portion of one face of the bearing is protruded and a recessed part for receiving a steel ball is formed in the protruded center portion as shown in FIG. 4. As such, the bearing is formed with a simple structure and thus the strength as a bearing is secured.

In accordance with an embodiment of the present invention, the bearing insertion hole provided in the bearing holder is formed as a hole for inserting the rotor into the rotor insertion hole of the stator.

According to this embodiment, since the bearing insertion hole provided in the bearing holder is used as a hole (entrance) through which the rotor is inserted to the inside of the stator, the whole length of the motor can be shortened.

In other words, according to this embodiment, the bearing holder can be shortened, and thus the whole length of the motor can be also shortened. Furthermore, even when the bearing holder is shortened, the function of bearing is sufficiently performed while strength is maintained.

In the conventional PM type stepping motor 100 (see FIG. 4), an inner diameter “B2” of the bearing insertion hole 105 of the bearing holder 140 is set to be equal to an inner diameter “C2” of the rotor insertion hole 103 of the stator 120 from a viewpoint of simplification of manufacturing (assembling) step. Therefore, at the time of assembling a motor, when the rotor 110 is inserted into the stator 120, the permanent magnet 102 may come into contact with the stator 120 (especially, with the pole teeth) to cause a motor damage. However, according to the present invention, for example, in FIG. 4, since the bearing insertion hole 105 whose inner diameter is smaller than the rotor insertion hole 103 of the stator 120 is used as a hole for inserting the rotor 110, the rotor 110 is inserted into the rotor insertion hole 103 in the state where the center of rotor shaft 101 is accurately coincided with the center of the rotor insertion hole 103 and thus the rotor shaft 101 of the rotor 110 is prevented from being eccentrically inserted into the rotor insertion hole 103. Accordingly, possibility of the motor damage can be reduced.

Other features and advantages of the invention will be apparent from the following detailed description, taken in conjunction with the accompanying drawings that illustrate, by way of example, various features of embodiments of the invention.

### BRIEF DESCRIPTION OF THE DRAWINGS

FIG. 1 is a cross-sectional view showing a mechanical structure of a PM type stepping motor in accordance with an embodiment of the present invention.

FIG. 2 is an enlarged explanatory view showing a portion around a bearing in the PM type stepping motor shown in FIG. 1.

FIG. 3 is an exploded perspective view for explaining a method for assembling a PM type stepping motor in accordance with an embodiment of the present invention.

FIG. 4 is a cross-sectional view showing a conventional structure of a PM type stepping motor provided with pole teeth.

### DETAILED DESCRIPTION OF THE PREFERRED EMBODIMENTS

An embodiment of the present invention will be described below with reference to the accompanying drawings.

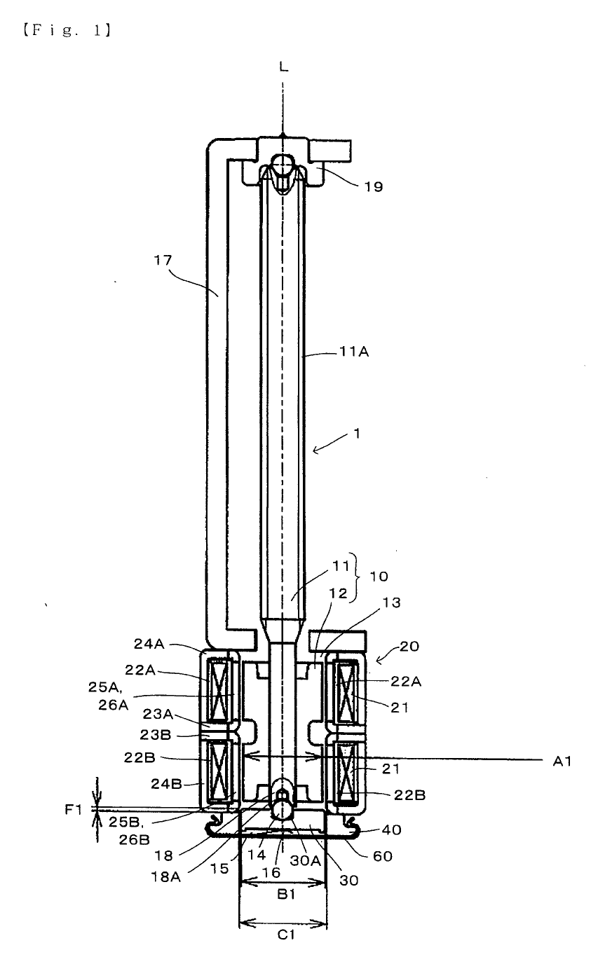

FIG. 1 is a cross-sectional view showing a mechanical structure of a PM type stepping motor 1 in accordance with an embodiment of the present invention. The PM type stepping motor 1 is mounted, for example, on an electronic apparatus such as a digital camera, a digital video camera, an FDD, or an ODD.

In FIG. 1, the PM type stepping motor 1 includes a rotor 10 provided with a permanent magnet 12 which is fixed to a rotor shaft 11, a stator 20 provided with a rotor insertion hole 13 into which the rotor 10 is inserted, a bearing 30 supporting a bottom end of the rotor shaft 11 through a steel ball 14, and a bearing holder 40 provided with a bearing insertion hole 15 for supporting the bearing 30 so as to be displaceable in an axial direction “L” of the rotor shaft 11. A flat spring 16 for applying pressurization in the axial direction “L” to the rotor 10 is abutted with an under face of the bearing 30.

In the stator 20, a first annular bobbin 22A around which a coil 21 is wound and a second annular bobbin 22B around which another coil 21 is wound are disposed so as to be superposed each other in the axial direction “L” of the rotor shaft 11. An inner ring-shaped stator core 23A and an outer ring-shaped stator core 24A are disposed on both sides of the first bobbin 22A in the axial direction “L” of the rotor shaft 11 in an superposed manner. Further, an inner ring-shaped stator core 23B and an outer ring-shaped stator core 24B are disposed on both sides of the second bobbin 22B in the axial direction “L” of the rotor shaft 11 in an superposed manner. A plurality of pole teeth 25A of the inner stator core 23A and a plurality of pole teeth 26A of the outer stator core 24A are disposed on the inner peripheral face of the first bobbin 22A such that respective pole teeth 25A are alternately disposed with respective pole teeth 26A in a circumferential direction. Further, a plurality of pole teeth 25B of the inner stator core 23B and a plurality of pole teeth 26B of the outer stator core 24B are disposed on the inner peripheral face of the second bobbin 22B such that respective pole teeth 25B are alternately disposed with respective pole teeth 26B in a circumferential direction. In accordance with an embodiment, the first bobbin 22A and the second bobbin 22B are made of a resin member, and the inner stator cores 23A, 23B and the outer stator cores 24A, 24B are made of a magnetic metal member.

As described above, the stator 20 is structured so as to have the rotor insertion hole 13 into which the rotor 10 is inserted. A base end side of the rotor 10 is disposed on an inner side of the rotor insertion hole 13 coaxially. A permanent magnet 12 is fixed to the rotor shaft 11 on the base end side, i.e., a rear side of the rotor 10. The permanent magnet 12 is disposed so as to face the pole teeth 25A, 26A, 25B and 26B of the stator 20 with a predetermined space.

A U-shaped frame (metal frame) 17 is fixed to a front end face of the outer stator core 24A. The rotor shaft 11 of the rotor 10 is supported by a thrust bearing 19 that is fixed to a bent portion on the front side of the frame 17. In other words, the front end of the rotor shaft 11 of the rotor 10 is pivotally supported by the frame 17. A lead screw part 11A is formed on the outer periphery of a portion of the rotor shaft 11 which protrudes on the frame 17 side. A screw part of a head member in an electronic apparatus such as a digital camera (not shown) to which this motor is mounted is threadedly engaged with the lead screw part 11A. When the lead screw part 11A is rotated, a head section arranged in the electronic apparatus on which this motor is mounted is vertically moved in the axial direction “L” of the rotor shaft 11 in FIG. 1.

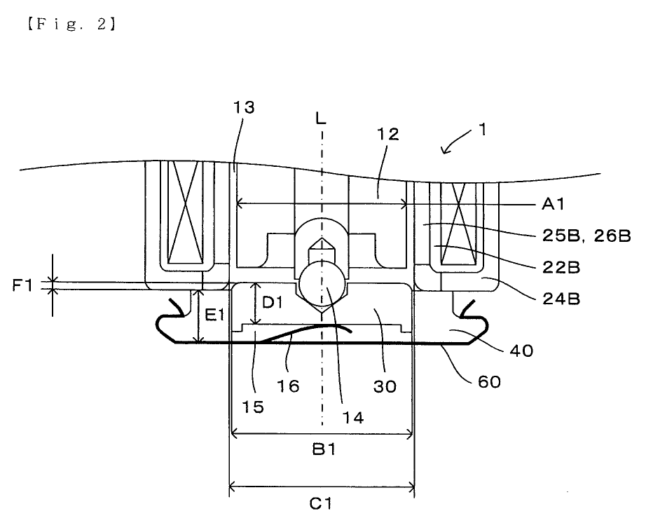

The shaft end 18 on the rear side in the axial direction “L” of the rotor shaft 11 of the rotor 10 is supported by a bearing 30 through a steel ball 14. The bearing 30 is formed in a circular plate shape with one diameter in the axial direction “L” of the rotor shaft 11. A front face of the bearing 30 is provided with a recessed part 30A which is formed with a conical recessed face for receiving the steel ball 14. The steel ball 14 is held between a recessed part 18A formed of a conical recessed face in the shaft end portion 18 and the recessed part 30A formed of the conical recessed face in the bearing 30. Specifically, the bearing 30 is structured of one piece of a circular plate-shaped member having a side circumferential face for abutting with, and sliding on, the bearing insertion hole 15 of the bearing holder 40, and two upper and lower flat faces, one face at each end of the side circumferential face of the bearing 30 in the axial direction “L” of the rotor shaft 11. The side circumferential face of the bearing 30, formed of one piece of a circular plate-shaped member, is formed as a sliding face for the bearing insertion hole 15 of the bearing holder 40. The recessed part 30A, for receiving the steel ball 14, is formed on one of the two flat faces, i.e., the upper flat face in FIG. 2. Further, the other of the two flat faces, i.e., the lower flat face in FIG. 2 is formed as an abutting face with the flat spring 16 which applies pressurization to the bearing 30. The bearing 30 is arranged such that the upper face in FIG. 2 is protruded on the rotor insertion hole 13 side.

As described above, the bearing holder 40, which is provided with the bearing insertion hole 15 and made of a sintered body, is disposed under the stator 20. The bearing 30 is mounted in the inside of the bearing insertion hole 15 in a state that the bearing 30 can be displaced in the axial direction “L” of the rotor shaft 11.

In accordance with an embodiment, an inside diameter “B1” of the bearing insertion hole 15 formed in the bearing holder 40 in the PM type stepping motor 1 is set to be larger than an outer diameter “A1” of the rotor 10. In addition, both the outer diameter “A1” of the rotor 10 and the inside diameter “B1” are set to be smaller than the inside diameter “C1” of the rotor insertion hole 13 formed in the stator 20. Further, the upper flat face of the bearing 30 protrudes from the upper end (end of the rotor 10 side) of the bearing holder 40 by an amount of “F1” and thus the bearing 30 protrudes on the rotor insertion hole 13 side in the stator 20. These dimensions will be described in detail below with reference to FIG. 2.

FIG. 2 is an enlarged explanatory view showing a portion around the bearing 30 in the PM type stepping motor 1 shown in FIG. 1.

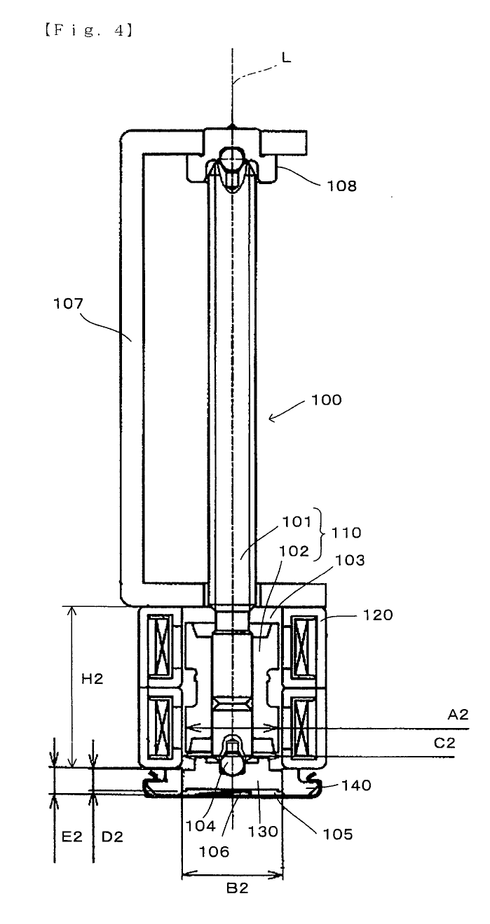

As shown in FIG. 2, in the PM type stepping motor 1, the smallest inside diameter “B1” of the bearing insertion hole 15 is the same size as the largest outer diameter “B1” of the circular plate-shaped bearing 30. The diameter “B1” is set to be smaller than the smallest inside diameter “C1” of the rotor insertion hole 13, and the bearing 30 protrudes into the rotor insertion hole 13. In this embodiment, the pole teeth 25A, 26A, 25B, and 26B of the stator 20 are disposed so as to face the permanent magnet 12. Therefore, the inside diameter formed by these pole teeth 25A, 26A, 25B, and 26B corresponds to the above-mentioned smallest inside diameter “C1” of the rotor insertion hole 13. As described above, this embodiment is structured such that the outer diameter “B1” of the circular plate-shaped bearing 30 is set to be smaller than the inside diameter “C1” of the rotor insertion hole 13, and the bearing 30 protrudes into the rotor insertion hole 13. Therefore, even when the length “D1” of the bearing 30 is equal to that of the conventional bearing (for example, even when the length “D1” is equal to the length “D2” shown in FIG. 4), the length “E1” of the bearing holder 40 can be made smaller (the length “E1” can be made smaller than the length “E2” shown in FIG. 4). Accordingly, in the case that the outer diameter of the PM type stepping motor 1 is set to be, for example, about φ6 mm, even when the length “E1” of the bearing holder 40 is also set to be relatively sufficiently smaller in comparison with the length of the stator 20, the length “D1” of the bearing 30 can be secured. Thus the total length of the motor can be made shorter (smaller) to cause to be capable of being mounted on a device such as a digital camera.

Further, even when the bearing 30 protrudes into the rotor insertion hole 13, the outer diameter “B1” of the bearing 30 is smaller than the inside diameter “C1” of the rotor insertion hole 13. Therefore, the bearing 30 is not brought into contact with the stator 20 (especially, not contact with the pole teeth 25B and 26B).

As described above, in the PM type stepping motor 1 in accordance with an embodiment of the present invention, the bearing 30 is structured as a circular plate-shaped bearing with one diameter in the axial direction of the rotor shaft 11. Further, the outer diameter “B1” of the bearing 30 is set to be smaller than the inside diameter “C1” of the rotor insertion hole 13 such that the circular plate-shaped bearing 30, with only one outer diameter along the axial direction, is capable of protruding into the rotor insertion hole 13. Therefore, the strength of the bearing 30 is sufficiently secured, the possibility of motor damage is reduced, and the size of the motor can be reduced.

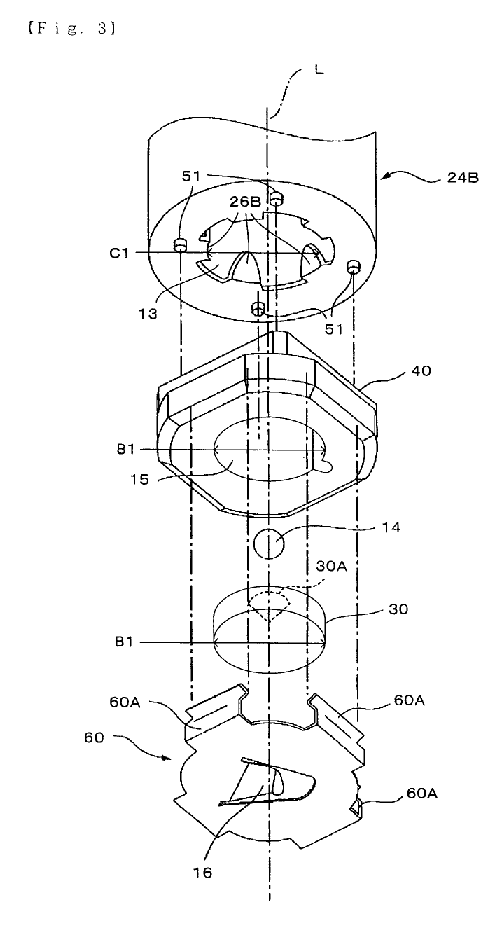

FIG. 3 is an exploded perspective view for explaining a method for assembling a PM type stepping motor 1 in accordance with an embodiment of the present invention. FIG. 3 is a view for describing an assembling method of the bearing 30 and the like in the PM type stepping motor 1. The frame 17, on which the thrust bearing 19 is mounted, is previously fixed to the front end face of the outer stator core 24A.

In FIG. 3, firstly, the bearing holder 40 is attached to the under face of the outer stator core 24B. More specifically, four protruded parts 51 for welding are formed on the under face of the outer stator core 24B, and the bearing holder 40 is positioned and abutted with the protruded parts 51. After that, an electric current is supplied to the protruded parts 51 to perform spot-welding and the bearing holder 40 is fixed to the outer stator core 24B.

Next, the bearing insertion hole 15 of the bearing holder 40 is used as a hole (entrance) for inserting the rotor 10 (not shown in FIG. 3 but see FIG. 1). More specifically, the rotor 10 is inserted from the bearing insertion hole 15 and its front end is engaged with the thrust bearing 19 (see FIG. 1).

In the PM type stepping motor 1 in accordance with an embodiment of the present embodiment, the inside diameter “B1” of the bearing insertion hole 15 is set to be smaller than the inside diameter “C1” of the rotor insertion hole 13 of the outer stator core 24B. Therefore, the bearing holder 40 can be made smaller while retaining its strength. Thus, the total length of the motor can be shortened. Further, when the rotor 10 is inserted into the stator 20, the rotor 10 can be inserted in a state where the center of the rotor shaft 11 accurately coincides with the center of the rotor insertion hole 13. Thus a situation is prevented where the rotor shaft 11 is inserted into the stator 20 in an eccentrically shifted manner. Therefore, possibility of the motor damage is reduced.

After the rotor 10 has been inserted into the stator 20, the bearing 30 is inserted into the bearing insertion hole 15 of the bearing holder 40. At this time, the steel ball 14 is held between the recessed part 18A (not shown in FIG. 3; see FIG. 1), formed at the shaft end 18 of the rotor shaft 11, and the recessed part 30A, formed in the bearing 30. Finally, a flat spring pressing cap member 60, having the flat spring 16, is attached to the bearing holder 40. More specifically, four pawl parts 60A which are extended from its outer peripheral edge part to the bearing holder 40 side are formed in the flat spring pressing cap member 60. The flat spring pressing cap member 60 is attached to the bearing holder 40 by these pawl parts 60A engaging with the outer peripheral edge part of the bearing holder 40. The under face (rear face) of the bearing 30 is urged by the flat spring 60 to prevent from generating a noise caused by shaking of the rotor shaft 11.

In accordance with an embodiment of the present invention, the bearing holder 40 is made of a member such as a sintered body. However, the bearing holder 40 is not so limited, and may be made of, for example, resin or the like.

A motor in accordance with the present invention is effective as a motor which is required to retain the strength of the bearing and reduce its size.

While the description above refers to particular embodiments of the present invention, it will be understood that many modifications may be made without departing from the spirit thereof. The accompanying claims are intended to cover such modifications as would fall within the true scope and spirit of the present invention.

The presently disclosed embodiments are therefore to be considered in all respects as illustrative and not restrictive, the scope of the invention being indicated by the appended claims, rather than the foregoing description, and all changes which come within the meaning and range of equivalency of the claims are therefore intended to be embraced therein.

What is claimed is:

1. A motor comprising:
a rotor including a permanent magnet which is fixed to a rotor shaft;
a stator including a rotor insertion hole and an inner periphery;
wherein the inner periphery of the stator is oppositely disposed to the permanent magnet of the rotor;
wherein the rotor insertion hole has a prescribed space and the rotor is inserted into the rotor insertion hole;
a bearing which supports one end of the rotor shaft; and
a bearing holder including a bearing insertion hole into which the bearing is inserted;
wherein an outer diameter of the permanent magnet of the rotor is set to be “A”, an inner diameter of the bearing insertion hole of the bearing holder is set to be “B”, an inner diameter of the rotor insertion hole of the stator is set to be “C”, and a relationship of “A<B<C” is satisfied.

2. The motor according to claim 1, wherein a part of the bearing protrudes from the bearing holder on a rotor insertion hole side of the bearing holder.

3. The motor according to claim 1, wherein the bearing insertion hole provided in the bearing holder is formed as a hole for inserting the rotor into the rotor insertion hole of the stator.

4. The motor according to claim 1, wherein a largest diameter of the outer diameter of the permanent magnet of the rotor is set to be “A”, a smallest diameter of the inner diameter of the bearing insertion hole of the bearing holder is set to be “B”, a smallest diameter of the inner diameter of the rotor insertion hole of the stator is set to be “C”, and the relationship of “A<B<C” is satisfied.

5. The motor according to claim 4, wherein
the bearing is structured of one piece of a circular plate-shaped member which includes a side circumferential face and two flat faces, the two flat faces sandwiching the side circumferential face;
the side circumferential face of the bearing is formed to be a slide face to the bearing insertion hole of the bearing holder;
a recessed part for receiving a steel ball is formed in one of the two flat faces; and
the other of the two flat faces is used as an abutting face with a flat spring for applying pressure to the bearing so that the one of the two flat faces of the bearing is urged to protrude to the rotor insertion hole side by the flat spring.

6. The motor according to claim 5, wherein the one of the two flat faces, where the recessed part for receiving the steel ball is formed, is comprised of only one flat face to the side circumferential face of the bearing.

7. A motor comprising:
a rotor;
a stator comprising a rotor insertion hole, an end of the rotor being inserted into the rotor insertion hole;
a bearing which supports the end of the rotor inserted into the rotor insertion hole; and
a bearing holder comprising a bearing insertion hole, the bearing being inserted into the bearing insertion hole;
wherein an outer diameter of the rotor is set to be “A”, an inner diameter of the bearing insertion hole of the bearing holder is set to be “B”, an inner diameter of the rotor insertion hole of the stator is set to be “C”, and a relationship of “A<B<C” is satisfied.

8. The motor according to claim 7,
wherein the rotor comprises:
a permanent magnet; and
a rotor shaft;
wherein the permanent magnet is fixed to the rotor shaft at the end of the rotor inserted into the rotor insertion hole;
wherein an outer diameter of the permanent magnet of the rotor is set to be “A”, an inner diameter of the bearing insertion hole of the bearing holder is set to be “B”, an inner diameter of the rotor insertion hole of the stator is set to be “C”, and the relationship of “A<B<C” is satisfied.

9. The motor according to claim 8, wherein
the stator further comprises an inner periphery; and
the inner periphery of the stator is oppositely disposed to the permanent magnet of the rotor.

10. A motor comprising:
a rotor;
a stator comprising a rotor insertion hole;
a bearing; and
a bearing holder comprising a bearing insertion hole;
wherein an outer diameter of the rotor is set to be “A”, an inner diameter of the bearing insertion hole of the bearing holder is set to be “B”, an inner diameter of the rotor insertion hole of the stator is set to be “C”, and a relationship of “A<B<C” is satisfied.
